(19) United States
(12) Patent Application Publication
(10) Pub. No.: US 2008/0261094 A1
(43) Pub. Date: Oct. 23, 2008

(54) STABILIZED ELECTRODES FOR ELECTROCHEMICAL CELLS

(76) Inventors: Stuart Licht, Milton, MA (US); Xingwen Yu, Vancouver (CA)

Correspondence Address: LOWRIE, LANDO & ANASTASI, LLP, ONE MAIN STREET, SUITE 1100, CAMBRIDGE, MA, 02142, US

(21) Appl. No.: 11/738,304

(22) Filed: Apr. 20, 2007

(51) Int. Cl. H01M 4/36; H01M 4/50; H01M 4/54; H01M 4/58

(52) U.S. Cl. 429/27; 429/122; 429/188; 429/218.1; 429/219; 429/221; 429/223; 429/224; 429/231.5

(57) ABSTRACT

Stabilized electrodes for electrochemical cells. An electrochemical cell based on an environmentally benign zirconia stabilized Fe⁶⁺/B²⁻ chemistry is disclosed. An electrochemical potential is sustained compatible to the pervasive, conventional alkaline (MnO₂—Zn battery), and with a much higher electrical storage capacity. Either or both the anode and cathode may be stabilized. For example, a zirconia overlayer on either TiB₂ or VB₂ boride anodes, and/or super-iron, K₂FeO₄, cathodes stabilizes the electrodes, while sustaining facile charge transfer. The energetic Fe⁶⁺ cathode elevates, and fully compensates for, the boride/zinc anode potential differential.

### FEDERALLY SPONSORED RESEARCH

This invention was made with Government support under Grant No. DE-FG02-04ER15585 awarded by the U.S. Department of the Energy. The Government of the United States may have certain rights in and to the invention claimed herein.

### FIELD OF THE INVENTION

At least one embodiment of the present invention relates generally to electrochemical cells and, more particularly, to stabilized electrodes for electrochemical cells.

### BACKGROUND OF THE INVENTION

For over a half century, the most common battery in use has remained a single discharge (“primary”) battery with a zinc (Zn) anode and a manganese dioxide (MnO₂) cathode, and on the order of 10¹⁰ of these cells are distributed annually. Introduced in 1866, the only significant chemical change has been replacement of the chloride, by hydroxide, electrolyte. After over a century of development, MnO₂/Zn chemistry is approaching fundamental storage limits that constrain device portability. Although capacity limited, one driving force for the continued societal use of these conventional batteries is the several generations of optical, electromechanical, electronic, medical, and more recently digital consumer devices, which have been designed for the normative 1.0-1.5 volts (V) optimal operative domain of the MnO₂/Zn battery.

The electroactive storage material is contained and constrained in a battery's cathode and anode electrodes. Solid boride anodes can store more charge than a zinc anode. However, several obstacles are evident towards implementation of this boride anodic chemistry. Borides corrode spontaneously over a large alkaline domain, generating hydrogen gas. The electrochemical potential of boron anodes is also lower than that of zinc. Therefore, a boride manganese dioxide cell is subject to decomposition, and its voltage is several hundred millivolts lower than a conventional Zn—MnO₂ battery.

### BRIEF SUMMARY OF THE INVENTION

In accordance with one or more embodiments, the invention relates generally to stabilized electrodes for electrochemical cells.

In accordance with one or more embodiments, the invention relates to an electrochemical cell, comprising an anode comprising a boron-containing material and a stabilizing agent, and a cathode in electrochemical contact with the anode.

In accordance with one or more embodiments, the invention relates to a method of generating a current, comprising applying a load to a battery including an anode comprising a boron-containing material and a stabilizing agent.

In accordance with one or more embodiments, the invention relates to a method of facilitating operation of an electrical device, comprising providing an electrochemical cell comprising an anode comprising a boron-containing material and a stabilizing agent, the electrochemical cell further comprising a cathode in electrochemical contact with the anode, and providing instructions directed to connecting the electrochemical cell to the electrical device.

In accordance with one or more embodiments, the invention relates to an alkaline battery, comprising an electrochemical cell constructed and arranged to exhibit an electrical storage capacity of at least about 1000 mAh/g of boride salt.

In accordance with one or more embodiments, the invention relates to an electrochemical cell, comprising an anode comprising a boron-containing material, and an iron(VI) cathode in electrochemical contact with the anode.

In accordance with one or more embodiments, the invention relates to an electrochemical cell, comprising a cathode comprising iron (VI) and a stabilizing agent, and an anode in electrochemical contact with the cathode.

In accordance with one or more embodiments, the invention relates to an electrochemical cell, comprising a cathode comprising a bismuth-containing material and a stabilizing agent, and an anode in electrochemical contact with the cathode.

In accordance with one or more embodiments, the invention relates to an electrochemical cell, comprising a cathode comprising a nickel-containing material and a stabilizing agent, and an anode in electrochemical contact with the cathode.

Other advantages, novel features and objects of the invention will become apparent from the following detailed description of the invention when considered in conjunction with the accompanying drawings.

### BRIEF DESCRIPTION OF THE DRAWINGS

The accompanying drawings are not intended to be drawn to scale. In the drawings, each identical or nearly identical component that is illustrated in various figures is represented by like numeral. For purposes of clarity, not every component may be labeled in every drawing. Preferred, non-limiting embodiments of the present invention will be described with reference to the accompanying drawings, in which:

FIG. 1 illustrates an electrochemical cell in accordance with one or more embodiments of the present invention;

FIG. 2 illustrates a half cell with a zirconia protected electrode in accordance with one or more embodiments of the present invention;

FIG. 3 presents data comparing the discharge of alkaline electrolyte cells containing various anode and cathode couples;

FIG. 4 presents data comparing discharges of titanium and vanadium boride anode alkaline batteries with a variety of cathodes;

FIG. 5 presents data comparing the capacity of super-iron boride alkaline batteries to that of the conventional (manganese dioxide/zinc) alkaline battery;

FIG. 6A presents ATR/FT-IR spectra of various uncoated and coated cathode materials;

FIG. 6B presents ATR/FT-IR spectra of various uncoated and coated anode materials;

FIG. 7 presents the discharge of KIO₄ as evaluated in Example 4 below;

FIG. 8 presents the discharge of K₂FeO₄ as evaluated in Example 4 below; and

FIG. 9 illustrates the energy advantage of boride air cells as discussed in Example 5 below.

### DETAILED DESCRIPTION OF THE INVENTION

This invention is not limited in its application to the details of construction and the arrangement of components as set forth in the following description or illustrated in the drawings. The invention is capable of embodiments and of being practiced or carried out in various ways beyond those exemplarily presented herein.

In accordance with one or more embodiments, the present invention relates generally to improved electrochemical cells. The electrochemical cells may include one or more stabilized electrodes as disclosed herein to facilitate utilization of various oxidation-reduction (“redox”) chemistries. The disclosed electrochemical cells may offer enhanced electrical storage capacity. Beneficially, in at least one embodiment the disclosed electrochemical cells may provide an average discharge potential similar to conventional alkaline MnO₂/Zn cells for compatibility with existing and developing electronic requirements. Furthermore, one or more of the disclosed electrochemical cells may be substantially environmentally benign.

In accordance with one or more embodiments, the disclosed electrochemical cells may offer improved electrical storage capacity. In some embodiments, an electrochemical cell may provide more storage capacity than a conventional MnO₂/Zn cell, which from the known, intrinsic two electron oxidation of zinc can provide up to 819.6 mAh/g Zn. For example, in some embodiments, an electrochemical cell may be constructed and arranged to provide an electrical storage capacity of at least about 1000 mAh/g of boride salt. In other embodiments, an electrical storage capacity of at least about 2000 mAh/g of boride salt may be provided. In still other embodiments, an electrical storage capacity of at least about 3000 mAh/g of boride salt may be provided. In at least one embodiment, a disclosed electrochemical cell may provide two or more times the storage capacity of a conventional MnO₂/Zn cell. An electrochemical cell may be constructed and arranged to exhibit an electrical storage capacity of at least about 3800 mAh/g of boride salt.

In accordance with one or more embodiments, disclosed electrochemical cells may be compatible with existing and/or developing electronic requirements. In at least one embodiment, the disclosed electrochemical cells may offer a standard or conventional electrochemical potential and/or average electrical discharge. For example, the disclosed electrochemical cells may generally be constructed and arranged to generate an electrochemical potential of about 1.5 V. In some embodiments, the average electrical discharge of the disclosed electrochemical cells may be, for example, from about 1.2 V to about 1.4 V.

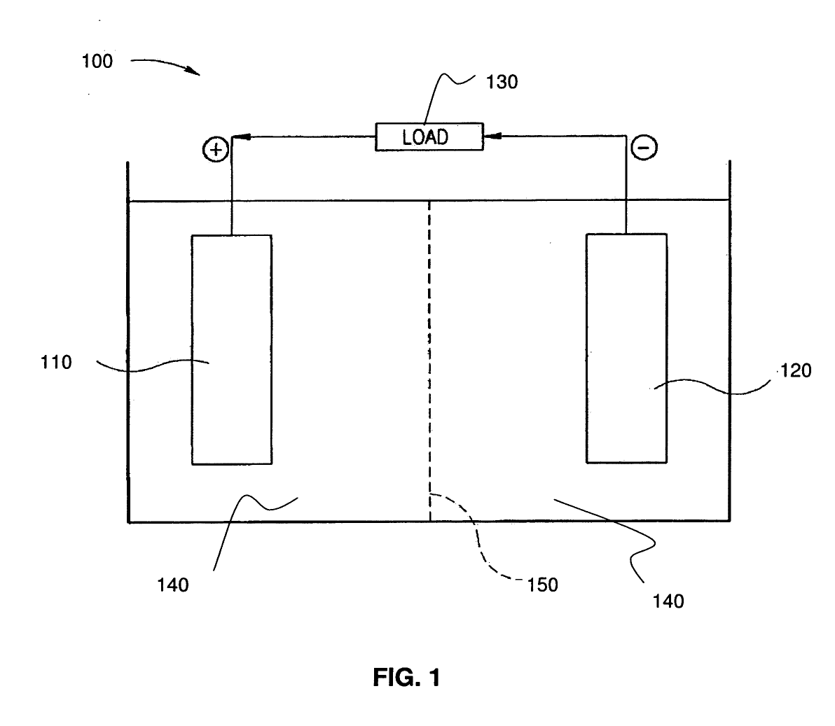

As illustrated in FIG. 1, an electrochemical cell 100 in accordance with one or more embodiments of the present invention may include a first electrode 110 and a second electrode 120 in electrochemical contact there between. Each of the first and second electrodes 110, 120 may function as an electrical conductor within electrochemical cell 100. In at least one embodiment, first electrode 110 may be a cathode wherein reduction reactions occur, and second electrode 120 may be an anode wherein oxidation reactions occur. Electrochemical cell 100 may be generally constructed and arranged to facilitate these coupled redox reactions occurring therein, as well as the transfer of electrons from anode 120 to cathode 110 to generate an electric current when a load 130 is applied. Electrolyte 140, an electrically neutral ionic conductor, may facilitate ionic transfer between cathode 110 and anode 120 within electrochemical cell 100 to drive the redox reactions. In some embodiments, electrolyte 140 of electrochemical cell 100 may be a hydroxide such as a potassium hydroxide or sodium hydroxide electrolyte.

First electrode 110 may be located within a first half-cell of electrochemical cell 100 and second electrode 120 may be located within a second half cell of electrochemical cell 100. Thus, each of the reduction and oxidation reactions may be representatively referred to as a half-reaction. The first and second half cells may be divided by a separator or an ion selective membrane 150, for example, to minimize non-electrochemical interaction between first and second electrodes 110, 120.

In at least one embodiment, electrochemical cell 100 may be an alkaline battery. In other embodiments, electrochemical cell 100 may be a fuel cell or any other type of electrochemical device commonly known to those skilled in the art. For example, first electrode 110 may be an air electrode in accordance with one or more embodiments of the present invention. The disclosed electrochemical cells may be single discharge or, alternatively, may be rechargeable (“secondary”) electrochemical cells.

In accordance with one or more embodiments, first electrode 110 may comprise any cathodic material commonly known to those skilled in the art. For example, the cathode may comprise manganese dioxide, nickel hydroxyl-oxide, a bismuth-containing material such as NaBiO₃, a periodate material such as KIO₄, or silver oxide. In at least one embodiment, first electrode 110 may comprise an iron (VI) salt. Without wishing to be bound by any particular theory, salts containing iron in the +6 valence state may be capable of multiple electron reduction to the +3 valence state, providing a high cathode storage capacity. First electrodes 110 may therefore be implemented based on iron (VI) chemistry in accordance with iron-based storage batteries as disclosed, for example, in U.S. Pat. Nos. 6,033,343 and 6,387,569, as well as U.S. Patent Application Publication Nos. 2002/0146618 and 2002/0155351, all to Licht, which are hereby incorporated herein by reference in their entirety for all purposes. For example, cathode 110 may comprise K₂FeO₄, Ag₂FeO₄, alkali (such as lithium sodium, rubidium and cesium) iron (VI) salts, alkali earth (such as strontium and barium) iron(VI) salts, or mixtures thereof.

In accordance with one or more embodiments, second electrode 120 may comprise any anodic material commonly known to those skilled in the art. In at least one embodiment, second electrode 120 may comprise a boron-based material. For example, anode 120 may comprise a metal boride such as VB₂, TiB₂, ZrB₂, MgB₂, CrB, CoB, LaB₆, or mixtures thereof. Without wishing to be bound by any particular theory, a boron-containing anode may be effective in storing several fold more charge than, for example, a conventional zinc anode.

In accordance with one or more embodiments, an electrochemical cell may include one or more stabilized electrodes. As used herein, the term “stabilized” refers generally to resistance to change, for example, regarding quality, character, attribute, nature and/or condition. In at least one embodiment, one or more of first and second electrodes 110, 120 may be substantially protected or stabilized against, for example, high temperatures, passivation and/or corrosion. As used herein, the term “passivation” refers generally to the changing of a chemically active surface to a less reactive state, and the term “corrosion” refers generally to a chemical or electrochemical reaction that causes deterioration of a material and/or its physical properties. The inherent stability of various anodic and/or cathodic materials may vary. For example, an iron (VI) salt may form a ferric overlayer, passivating the cathode from further discharge. Likewise, boron may tend to spontaneously corrode, particularly over a large alkaline domain.

In accordance with one or more embodiments, at least one of the first and second electrodes 110, 120 may comprise a stabilizing agent. The stabilizing agent may generally be effective in protecting the electrode. More specifically, the stabilizing agent may comprise a material capable of protecting the electrode from high temperatures, passivation and/or corrosion. Thus, the stabilizing agent may, for example, be an anti-passivation and/or an anti-corrosion agent. In some embodiments, the stabilizing agent may be substantially insoluble, so as to maintain integrity within the environment of electrochemical cell 100. In at least one embodiment, the stabilizing agent may be an ion conductor, such as a hydroxide ion conductor, to generally enable electrolyte 140 to facilitate redox reactions within electrochemical cell 100.

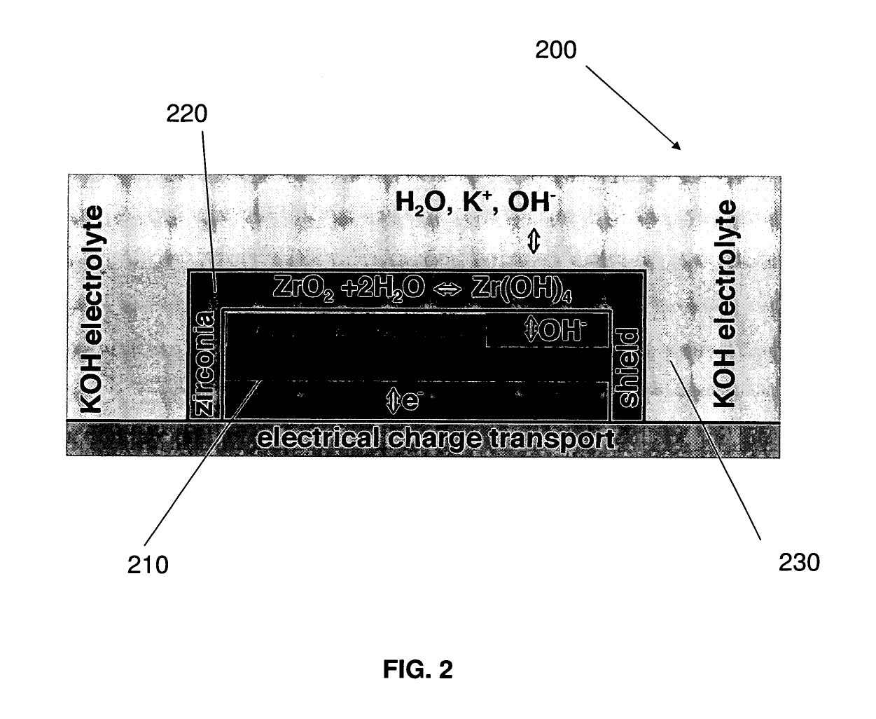

For example, the stabilizing agent may comprise zirconia in accordance with one or more embodiments. FIG. 2 representatively illustrates an electrochemical half cell 200 in which electrode 210 is protected by zirconia stabilizing agent 220 which is substantially insoluble in electrolyte 230. In accordance with one or more embodiments, zirconia derived from an organic soluble zirconium salt may be utilized to stabilize one or more electrodes, taking advantage of the fact that zirconia is practically insoluble (Kₛₚ=8×10⁻⁵²) and stable in aqueous alkaline media.

The zirconia may be present in an effective amount sufficient to generally stabilize an electrode. The zirconia may also be present in an effective amount to facilitate charge retention. Excess zirconia may generally lead to overpotential of an electrode while too little may be insufficient for maximum charge retention. In some embodiments, for example, zirconia stabilizing agent may be present in an amount from about 0.1 wt. % to about 10 wt. % of the electrode. In at least one embodiment, zirconia may be present in an amount from about 0.3 wt. % to about 5 wt. % of the electrode. In accordance with one or more embodiments, zirconia may be present in an amount of about 1 wt. % of the electrode.

The stabilizing agent, such as zirconia, may be included in an electrode in any manner commonly known to those skilled in the art. For example, in some embodiments zirconia may be applied to an outer surface of the electrode, such as with a coating technique. In other embodiments, materials of the electrode may be stabilized with zirconia prior to electrode formation. For example, zirconia may be applied to one or more electrode materials prior to electrode formation. In at least one embodiment, an electrode material may be coated or encapsulated with zirconia prior to electrode formation. For example, a zirconium salt may be dissolved in a solvent, such as an ether, and then mixed with an electrode material, such as boron-containing powder. The solvent may then be evaporated and the mixture dried to create zirconia stabilized boron. The stabilized electrode material may then be mixed with other electrode materials, such as conductive materials and binders, to form an electrode. For simplicity, the term “coating” may be used generally to refer to the stabilizing agent of an electrode in accordance with one or more embodiments of the present invention. A more detailed description of the formation/protection mechanism for zirconia coated electrodes is presented in the article by Licht et al., Cathodic Chemistry of High Performance Zr Coated Alkaline Materials, Chem Commun (Camb) Nov. 4. 2006;(41):4341-3, which is hereby incorporated herein by reference in its entirety for all purposes. The Examples presented further below may also generally involve this evaporative coating technique for stabilizing electrodes.

An electrochemical cell in accordance with one or more embodiments of the present invention may include any combination of anode and cathode as disclosed herein. For example, in one embodiment an electrochemical cell may include an anode comprising a boron-containing material. In another embodiment, an electrochemical cell may include an iron (VI) cathode. In yet another embodiment, an electrochemical cell may include an anode comprising a boron-containing material and an iron (VI) cathode. Either or both the anode and cathode of a disclosed electrochemical cell may be stabilized, for example, with zirconia.

In accordance with one or more embodiments of the present invention, an effective, unusual alternative to alkaline manganese zinc battery chemistry is introduced, utilizing the simultaneous 5 electron (e⁻) oxidation of boride and 3e⁻ reduction of super-oxidized valence state iron, and storing considerably higher electrochemical energy. In at least one embodiment, the present invention relates to a new realm of alkaline batteries based on an environmentally benign zirconia stabilized Fe⁶⁺/B²⁻ chemistry, which sustains an electrochemical potential compatible to the pervasive, conventional alkaline (MnO₂—Zn) battery, however with a much higher electrical storage capacity. A zirconia overlayer on either TiB₂ or VB₂ boride anodes, or super-iron, such as K₂FeO₄, cathodes prevents alkaline passivation, while sustaining facile charge transfer. VB₂ exhibits an anodic capacity 5.0 times that of zinc. Without wishing to be bound by any particular theory, the energetic Fe⁶⁺ cathode may be effective in elevating, and fully compensating, for the boride/zinc anode potential differential. The combined super-iron boride chemistry may generate an E°=1.5 V, and an average discharge of 1.2-1.4 V.

The function and advantages of these and other embodiments of the invention can be further understood from the examples below, which illustrate the benefits and/or advantages of the system and methods of the invention but do not exemplify the full scope of the invention.

### EXAMPLE 1

### Comparative Discharge of Conventional, Super-Iron Cathode, and Boride Anode, Alkaline Batteries

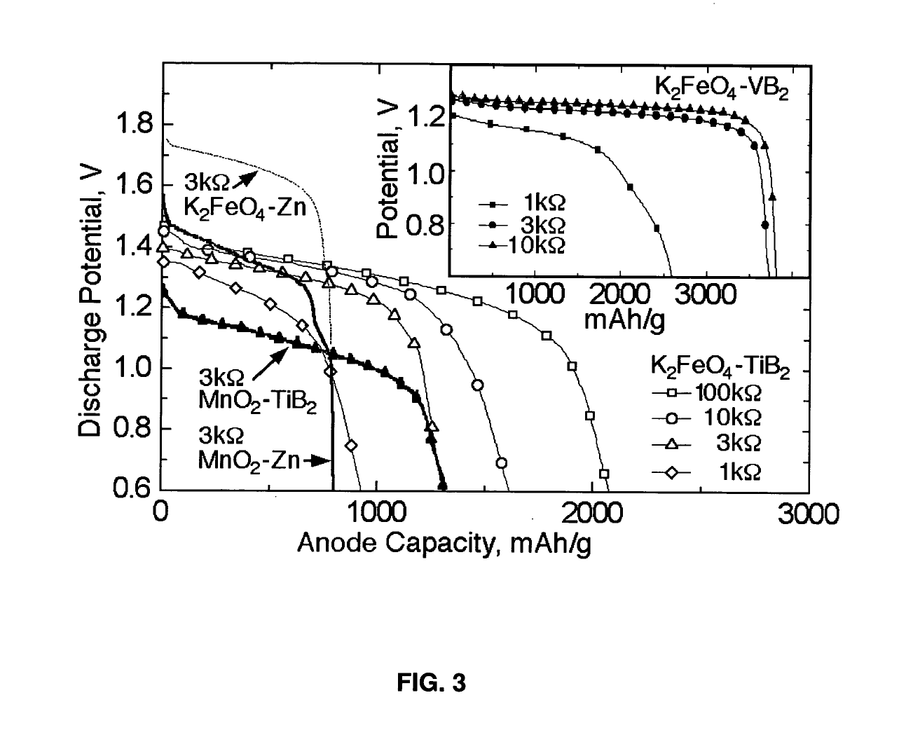

FIG. 3 compares the discharge of alkaline electrolyte cells containing various anode and cathode couples. Anodes were studied in cells with excess intrinsic cathode capacity, in a 1 cm button cell, discharged under the indicated constant ohmic load conditions. Cells contained a (conventional) MnO₂ cathode/Zn anode, or a K₂FeO₄ cathode, and/or a boride anode, and a KOH electrolyte. The boride anode was either TiB₂ (Aldrich 10 μm powder) or VB₂ (Aldrich 10 μm/325 mesh powder), and contained 75% of the boride salt, 20% 1 μm graphite (Leico), 4.5% KOH and 0.5% binder (T-30, 30% teflon). The anode mixture was compressed onto a piece of graphite foil (Alfal Aesar). The K₂FeO₄ cathode, and the button cell configuration, were prepared as described, for example, in Example 4 below.

It is evident that the MnO₂/boride cell generates 0.2-0.3 V lower discharge potential, while the potential generated by the super-iron/zinc cell is 0.2-0.3 V higher, than that of the conventional MnO₂/zinc cell. However, the new Fe⁶⁺/B²⁻ system generates an open circuit potential of 1.5 V, and as evident in FIG. 3, an average discharge potential similar to the conventional alkaline MnO₂/zinc cell, and which is compatible with existing electronic requirements.

As seen in FIG. 3, zinc anode cells (either with an MnO₂ or K₂FeO₄ cathode) approach the known, intrinsic 819.6 mAh/g 2e⁻ storage capacity of zinc. In addition to the discharge potential, an advantage of the alkaline Fe⁶⁺/B²⁻ chemistry is the higher intrinsic capacity compared to that of MnO₂/Zn. As seen in FIG. 3, the titanium boride anode discharge is in excess of 2000 mAh/g. Without being bound to any theory, the alkaline discharge of the TiB₂ anode is an unusual 6e⁻ process. This simultaneously includes a 5e⁻ oxidation, B(−II=>III), for each of two boride to borate oxidations, accompanied by a 4e⁻ reduction of titanium Ti(IV=>0) to amorphous titanium:

TiB₂+12OH⁻→Ti(amorphous)+2BO₃³⁻+6H₂O+6e⁻ (1)

In accord with Eq. 1, and a formula weight, W=69.5 g mol⁻¹, TiB₂, has a net intrinsic 6e⁻ anodic capacity of 6F/W=2314 mAh/g (F=the faraday constant). In addition to Eq. 1, the small third acid dissociation constant of boric acid (pKₐ₃(H₃BO₃)=13.8), drives BO₃³⁻ hydrolysis to spontaneously buffer hydroxide depletion during discharge:

2BO₃³⁻+2H₂O [symbol] 2OH⁻+2HBO₃²⁻ (2)

The vanadium boride anode, VB₂, has 5.0 times the alkaline capacity of zinc. Unlike TiB₂, the alkaline VB₂, undergoes an oxidation of two borons and the tetravalent transition metal ion, with V(IV [symbol] V), which is a net 11e⁻ anodic process. Without being bound to any theory, therefore in accord with Eq. 3, VB₂, will have an intrinsic 11e⁻ anodic capacity of 11F/(W=72.6 g mol⁻¹)=4060 mAh/g, rivaling the high anodic capacity of lithium (3860 mAh/g).

VB₂+20OH⁻→VO₄³⁻+2BO₃³⁻+10H₂O+11e⁻ (3)

At open circuit, it was measured for Eqs. 1 and 3: E°(TiB₂)=0.97 V and E°(VB₂)=0.91 V versus standard hydrogen. As evident in the inset of FIG. 3, the vast majority of the substantial capacity of VB₂ (3800 mAh/g) is realized in the discharge of the alkaline super-iron vanadium boride cell. Compared to TiB₂, the VB₂ anode cells exhibit less voltage drop with increasing depth of discharge, and attain a larger relative portion of their intrinsic capacity at lower fixed load (e.g. at 3K or 10K Ω).

### EXAMPLE 2

### Comparative Discharges of Titanium or Vanadium Boride Anode Alkaline Batteries with a Variety of Cathodes

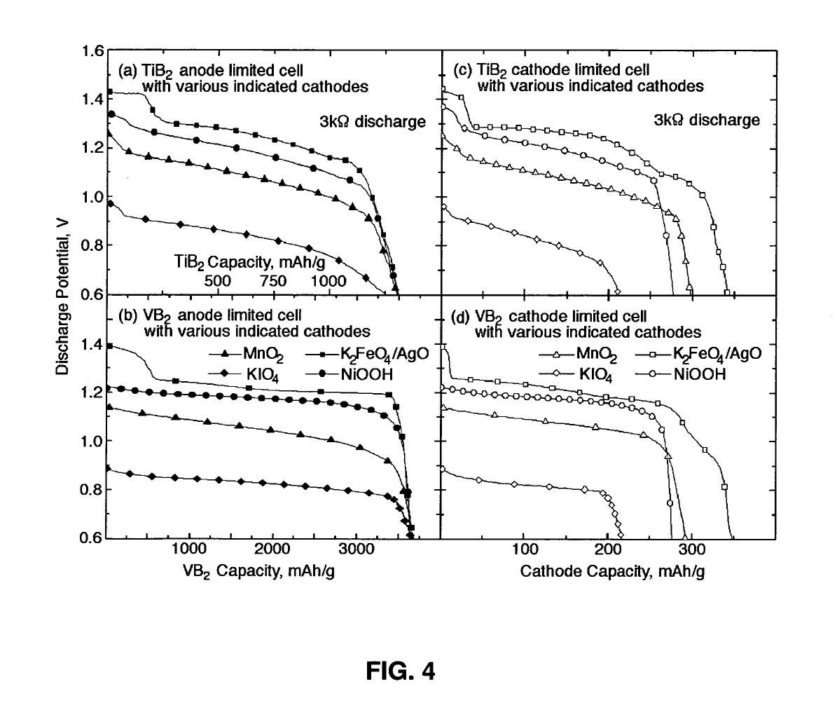

With reference to FIG. 4, comparative discharges of titanium (top) or vanadium (bottom) boride anode alkaline batteries with a variety of cathodes, under (left) anode limited or (right) cathode limited conditions were studied. In each case, 1 cm button cells were discharged at a constant 3 kΩ load conditions. The TiB₂ or VB₂ anodes used were as described in Example 1 above. The cathode was either (square symbol) 76.5% ZrO₂ coated K₂FeO₄, 8.5% AgO, 5% KOH and 10% 1 μm graphite; or (circle) 90% MnO₂ (EMD, EraChem K60) and 10% 1 μm graphite; or (triangle) NiOOH (from a commercial Powerstream Ni-MH button cell); or (diamond) 75% KIO₄ (ACROS) and 25% 1 μm graphite. Anode, or cathode, limited conditions were studied by packing each cell, respectively, with excess intrinsic cathode, or anode capacity.

FIG. 4 probes the boride anode cells, not only under anode-limited, but also with a variety of cathode-limited conditions. Other cathodes including the conventional MnO₂ and NiOOH electrodes, and a periodate (KIO₄) cathode are also alkaline compatible with the boride anode. The highest cathodic capacity was that of the Fe⁶⁺ cathode, as shown on the right side (top and bottom) of FIG. 4, and also evident was that cathode's higher discharge potential with boride anodes, compared to the alternate alkaline cathodes.

Without being bound to any theory, an alkaline super-iron cathode, stores charge via a 3e⁻ Fe(VI=>III) reduction, to a ferric hydroxide or oxide product, varying with the depth of discharge and degree of dehydration.

FeO₄²⁻+3H₂O+3e⁻″FeOOH+5OH⁻ (4)

FeO₄²⁻+5/2H₂O+3e⁻→1/2Fe₂O₃+5OH⁻ (5)

K₂FeO₄ has an intrinsic 3e⁻ cathodic storage capacity of 3F/(W=198 g mol⁻¹)=406 mAh/g, much higher than that of MnO₂ (308 mAh/g). Hydroxide and Ag(II) additions mediate Fe⁶⁺ charge transfer. Consistent with this observation, in lieu of the pure K₂FeO₄ salt utilized in FIG. 3 (75% K₂FeO₄/25% graphite cathode), the K₂FeO₄ cathode includes AgO and KOH. This permits the Fe⁶⁺ cathode to sustain higher current densities, and greater depth of discharge, with considerably less graphite added as a conductive matrix, and the FIG. 4 cathode contains in addition to a K₂FeO₄ salt, 8.5% AgO, 5% KOH and only 10% graphite.

The small voltage plateau evident in FIG. 4, during the initial discharge of the Fe⁶⁺ cathode, is largely due to the Ag(II [symbol] I) reduction of the added AgO. In addition, the voltage plateaus visible for each of the non-Fe⁶⁺/TiB₂ cells, during the initial discharge, (FIG. 4 top, left and right), but not evident in the VB₂ cells (bottom, left and right), are consistent with complexities attributed to the simultaneous Ti(IV) reduction. In conventional alkaline cells, the MnO₂ cathode exhibits a steep voltage decrease with increasing depth of discharge. This voltage loss increases with increasing discharge rate, and decreases the high rate storage capacity of alkaline MnO₂/Zn cells. The alkaline NiOOH cathode exhibits less of this voltage loss, and the 3e− alkaline discharge profile of the Fe⁶⁺ cathode is similarly flat. The alkaline MnO₂/boride cell also exhibits the typical MnO₂ voltage drop in FIG. 4. As noted in FIG. 3, VB₂ anodes exhibit less polarization than TiB₂, and as seen on the left bottom of FIG. 4, in conjunction with a VB₂ anode, the NiOOH and Fe⁶⁺ cathodes exhibit less voltage drop with increasing depth of discharge, than for a MnO₂ cathode.

### EXAMPLE 3

### Capacity (Anode+Cathode) of the Super-Iron Boride Alkaline Battery Compared to the Conventional (Manganese Dioxide/Zinc) Alkaline Battery

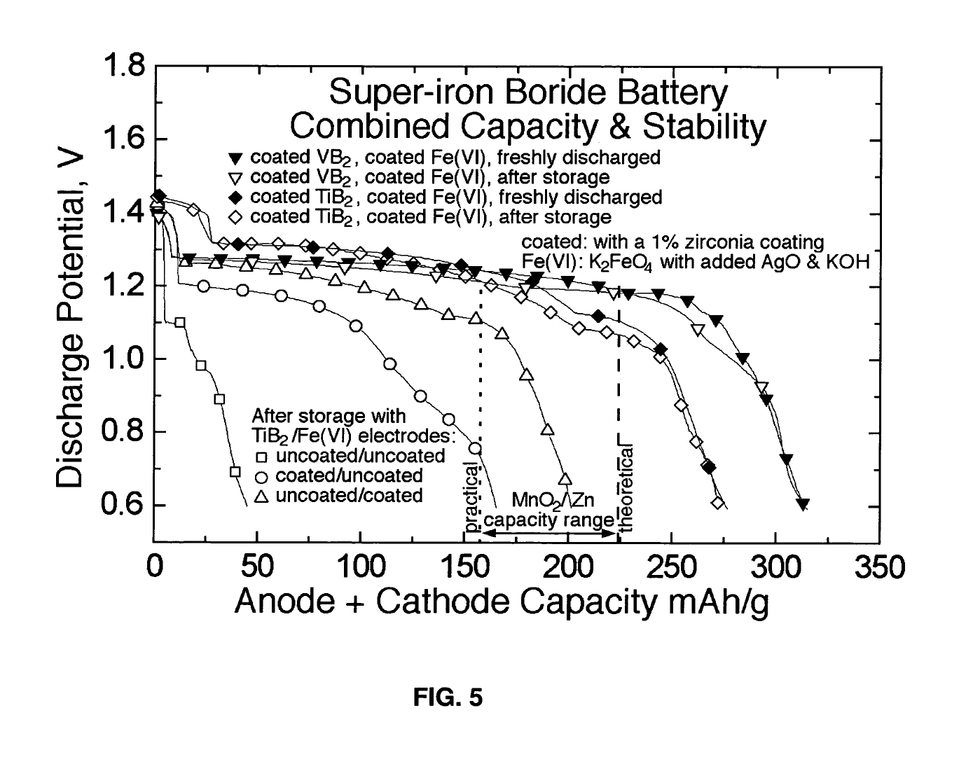

The super-iron boride cell which was used contained either a titanium, or a vanadium, boride anode, as indicated in FIG. 5. The cathode was 76.5% K₂FeO₄, 8.5% AgO, 5% KOH and 10% 1 μm graphite. Charge retention (stability) of the cells were compared freshly discharged, and after 1 week storage, with, or without, a 1% zirconia coating applied to the Fe(VI) or boride salts.

The range from practical to theoretical (2F per Zn+2MnO₂), maximum capacity of the conventional alkaline battery is shown as dashed vertical lines in FIG. 5. The theoretical capacity for the Fe⁶⁺/B²⁻ chemistry varies with the super-iron and boride counter ion. Here, the titanium boride (6F per TiB₂+2K₂FeO₄) and super-iron vanadium boride (33F per 3VB₂+11K₂FeO₄) chemistries yield an intrinsic 345 and 369 mAh/g, and are higher than the intrinsic MnO₂—Zn capacity of 222 mAh/g. The experimental Fe⁶⁺/B²⁻ full capacity is investigated in FIG. 5, discharging cells with balanced anode and cathode capacity (based on the intrinsic capacity of the anode and cathode components).

Without being bound to any theory, the reaction products will depend on the depth of discharge, pH and the degree of dehydration of the boric and ferric products (Eqs. 2, 4-5), and for a titanium boride anode, the cell may be generalized in the representative deep discharge reaction:

TiB₂+2FeO₄²⁻→Ti+2Fe₂O₃+2HBO₃²⁻ (6)

The discharge products of the Fe⁶⁺/B²⁻ system, ferric oxide and boric acid, are environmentally benign. The limiting capacity of the super-iron boride cell will vary with cell configuration and rate of discharge. Without being bound to any theory, the hydroxide and charge balanced super-iron vanadium boride cell requires less BO₃³⁻ hydrolysis than the analogous titanium cell:

VB₂+11/3FeO₄²⁻+5/6H₂O→11/6Fe₂O₃+VO₄³⁻+1/3BO₃³⁻+5/3HBO₃²⁻ (7)

As seen in FIG. 5, the super-iron titanium boride cell combined anode and cathode capacity experimentally exceeds 250 mAh/g, and that of the super-iron vanadium boride cell is over 300 mAh/g, which is twice that of the conventional alkaline battery chemistry (MnO₂/Zn).

TiB₂ visibly reacts on contact with KOH electrolyte (evolving hydrogen). This is not only a chemical loss of the electrochemical capacity and is flammable, but in addition due to the evolved gas, a sealed battery will swell or even crack during storage. A low level (1%) zirconia coating, generated in the same manner which had been applied to stabilize the Fe⁶⁺ cathode, stops this chemical decomposition of the anode. Fe⁶⁺ tends to form a ferric overlayer; the bulk super-iron remains active, but the overlayer would inhibit cathodic charge transfer. This Fe⁶⁺ alkaline passivation is suppressed through a zirconia overlayer to mediate hydroxide transport to the electrode. Stabiized zirconia was introduced as a pH sensor for high temperature aqueous systems, and Zr(OH)₄ is a hydroxide ion conductor, which will readily exchange between solution phase hydroxide, phosphate fluoride, and sulfate.

A 1% ZrO₂ coating was formed via 8 mg ZrCl₄ (AR grade, ACROS®), dissolved in 8 ml ether (Fisher®) and the overlayer provides an ionic conductive, alkaline stable coating. As with super-iron salts, the boride salts are insoluble in the ether coating solution. The solution was stirred with 0.8 g of the solid powder anode or cathode salt in air for 30 min., followed by vertex suction, then vacuum removal of the remaining solvent, and drying overnight.

A 1% zirconia coated titanium boride does not evolve hydrogen. Stability, of not only the K₂FeO₄ cathode, but also the TiB₂ anode, dramatically improves with this zirconia coating. As seen in FIG. 5, after one week storage, the uncoated super-iron titanium boride cell generated only 10-15% of the 3 kΩ discharge capacity of the fresh cell. One hundred percent of the charge capacity is retained after 1 week storage, when zirconia coated super-iron and zirconia coated boride are utilized. In lieu of the uncoated electrodes, if either anode or cathode (but not both) is coated, then a large fraction, but not all, of the charge capacity is lost. Also evident in FIG. 5, the zirconia coated super-iron vanadium boride cell retained its substantial charge capacity after 1 week of storage. Charge retention on the order of weeks at room temperature for the super-iron boride cells is comparable to that observed in early alkaline primary cells, as well as contemporary alkaline rechargeable cells. Longer duration, and higher temperature, storage is preferred. The vanadium boride anode exhibited higher stability than the titanium boride anode. Without the zirconia coating, after one week storage the vanadium boride anode retained 65% of the original charge capacity at 70° C. (85% with zirconia coating), and 90% of the charge capacity at 45° C. (100% with the zirconia coating).

The super-iron boride chemistry exhibited substantially higher charge storage than conventional alkaline primary storage chemistry. The study was limited to available titanium and vanadium boride salts. A further optimization of both the boride and super-iron salt particle size, coupled with study and variation of the zirconia coating, should further enhance cell longevity. Alternate metal borides, as well as alternate super-irons will also affect characteristics of the super-iron boride cell capacity. Expected high intrinsic alkaline capacities of alternate borides include that for ZrB₂, MgB₂, CrB₂, CoB, NiB₂, TaB, TaB₂ and LaB₆. In addition to K₂FeO₄, the cathodic behavior of a variety of Fe⁶⁺ salts has been studied including Ag₂FeO₄, and other alkali (lithium, sodium, rubidium and cesium) and alkali earth (strontium and barium) Fe⁶⁺ salts, and further understanding of the charge transfer of these, and other, unusual super-iron salts will also impact charge transfer, retention, capacity of the new super-iron boride chemistry.

### EXAMPLE 4

### Chemistry of Zirconia Coated Alkaline Materials

Ether was chosen as a coating solvent due to its facile evaporation (BP=34° C.), ZrCl₄ solubility, and no reaction or solubility with the cathode materials. 8 mg ZrCl₄ (AR grade, ACROS®) was dissolved in 8 ml ether (Fisher®), and stirred with 0.8 g solid (insoluble) K₂FeO₄ in air for 30 min., followed by vertex suction, then vacuum removal of the remaining solvent, and drying overnight. K₂FeO₄ of 97-98.5% purity was prepared by alkaline reaction of Fe(NO₃)₃ with KClO. AgO,was prepared by the 85° C. alkaline reaction of AgNO₃ with K₂S₂O₈. Other cathode materials MnO₂ (EraChem K60), NiOOH (from Powerstream® Ni-MH button cell), NaBiO₃ (ACROS®) and KIO₄ (ACROS®), and AgO were effectively coated with the same methodology.

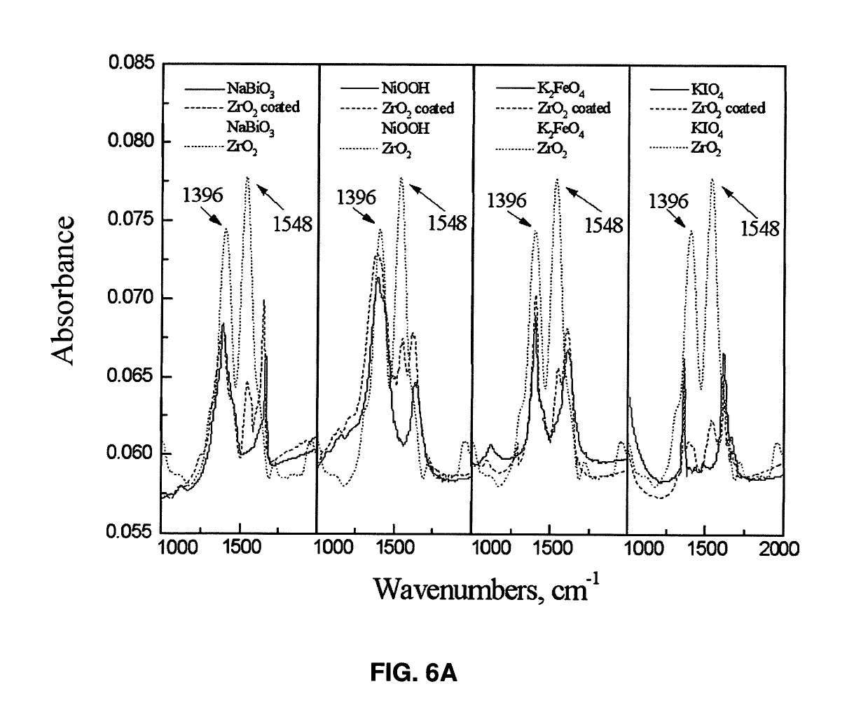

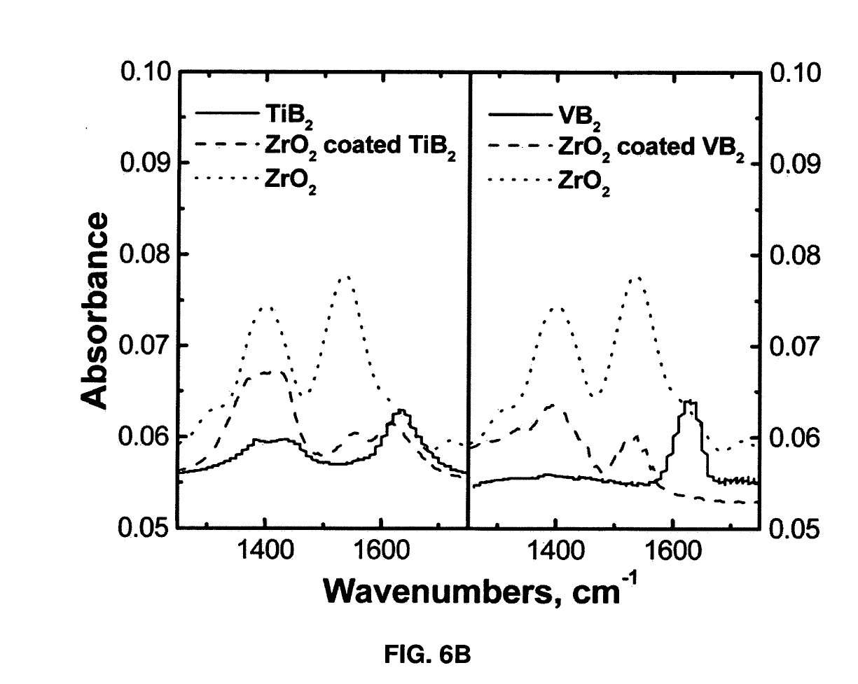

Analysis of the coating was performed with Attenuated Total Reflectance Fourier Transform Infrared (ATR/FT-IR) Spectrometry (Nicolet 4700), in which the powder sample was compressed to a thin pellet and pressed firmly onto a Smart Orbit (Thermo Electron Corporation) diamond crystal. ATR/FT-IR spectra of several uncoated and coated cathode materials are shown in FIG. 6A. Pure ZrO₂ was prepared (as a colloid without the cathode salt) for comparison. The prominent 1608 cm⁻¹ peak of the commercial ZrCl₂ fully disappears (not shown), and as seen in FIG. 6A, new 1396 and 1548 cm⁻¹ peaks on the coated material coincides with the absorption spectra of pure ZrO₂/Zr(OH)₄ depending on extent of hydration:

ZrCl₄+2O₂→ZrO₂+2Cl₂; ZrO₂+2H₂O [symbol] Zr(OH)₄ (8)

High capacity boride anodes were also modified with zirconia. ATR/FT-IR analysis results of uncoated and coated VB₂, TiB₂ anodes are shown in FIG. 6B. Pure ZrO₂ was prepared (as a colloid) for comparison. Similar to the coated cathode materials of FIG. 6A, the 1396 and 1548 cm⁻¹ peaks on the coated TiB₂ and VB₂ coincide with the absorption spectra of pure ZrO₂/Zr(OH)₄. Spectra of 5% coating are presented for emphasis. A 1% zirconia coating exhibits evident, but proportionally smaller, 1396 and 1548 cm⁻¹ peaks.

1 wt. % zirconia coating, prepared with 30 min. coating time, was observed to have the best effect on charge retention of a coated cathode. 0.3 to 5% zirconia coatings were prepared. Excess coating is observed to the cathode overpotential, whereas, a lesser coating is insufficient for maximum charge retention. Smaller particle anode and cathode salts with thick zirconia overlayers can also be more stable and more electrochemically active.

The effect of the 1% zirconia coating on alkaline cathodes can be dramatic. Electrochemical enhancement of the zirconia coating was evaluated through preparation of alkaline (metal hydride anode) button cells with coated, or uncoated, cathodes. Cathodes were composed of 20 mAh of KIO₄ or K₂FeO₄ (coated or uncoated), with graphite as a conductor (1μ graphite, Leico Industries Inc.). Saturated KOH was used as the electrolyte, and the metal hydride anode was removed from a Powerstream® Ni-MH button cell. Cells were discharged at constant load of 3000Ω; the potential variation over time was recorded via LabView Acquisition on a PC, and the cumulative discharge determined by subsequent integration.

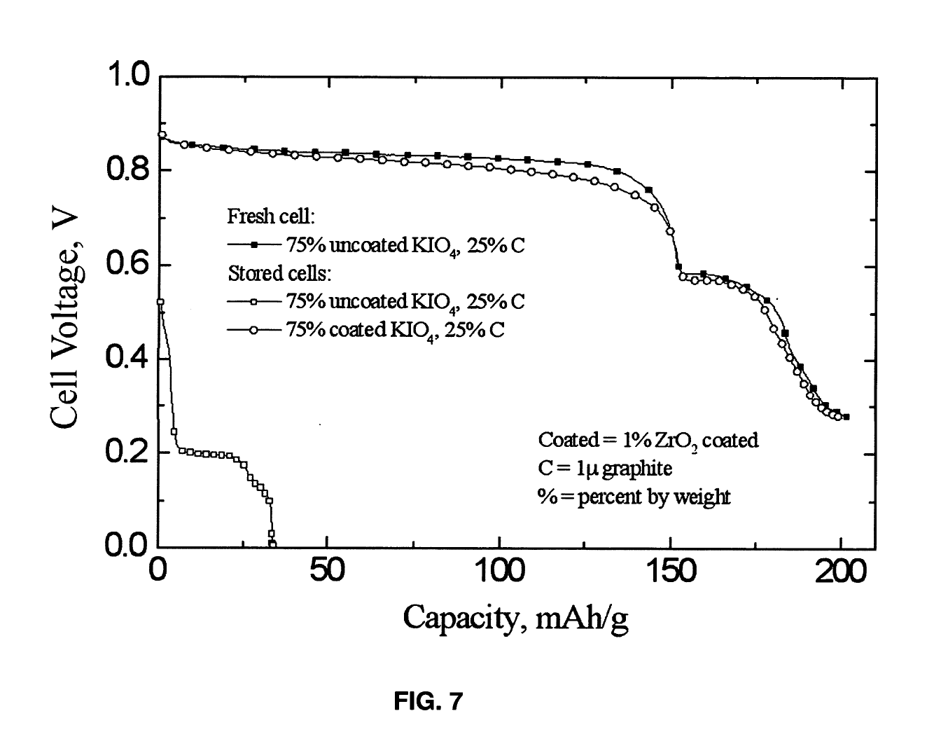

FIG. 7 presents the discharge of KIO₄. Typical of other multiple e− alkaline cathodes, the cathode passivates, and after 7 days storage the discharge is only a small fraction of its initial capacity. However, as seen with a 1% zirconia coating the initial discharge capacity is retained. The insoluble Zr centers provide an intact shield, and with eq. 8, a necessary hydroxide shuttle to sustain alkaline cathode redox chemistry.

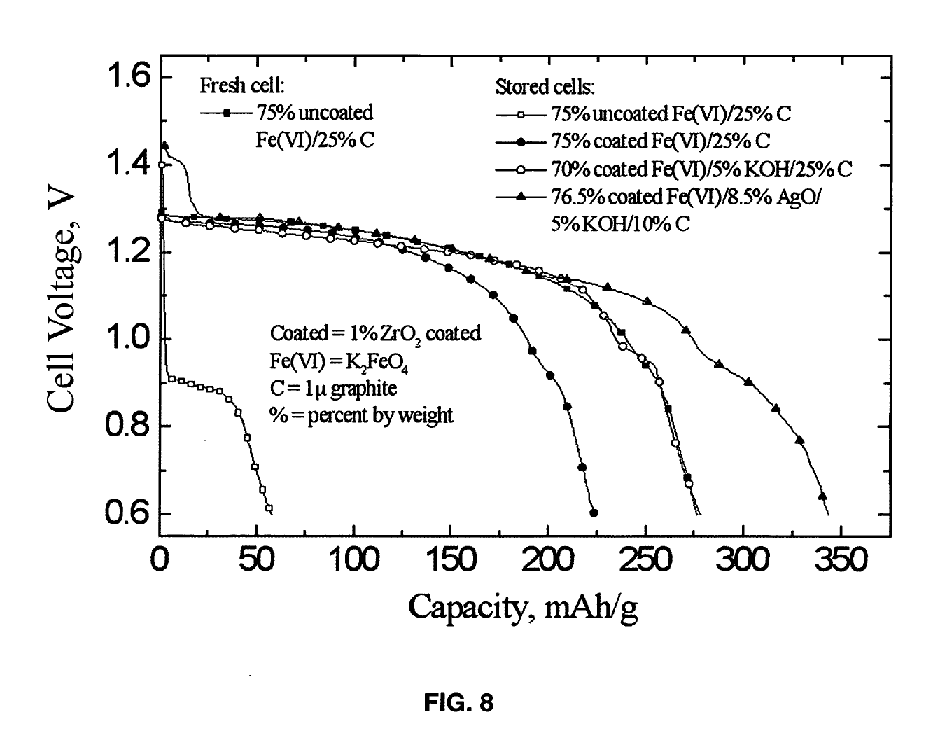

Among the super-iron cathodes, K₂FeO₄ exhibits higher solid state stability (<0.1% decomposition/year) and higher intrinsic 3e− capacity than pure BaFeO₄, but the rate of charge transfer is higher in the latter. Charge transfer is enhanced many-fold in K₂FeO₄ by small additions of AgO or KOH, and at low current densities the cathode approaches the intrinsic over 400 mAh/g storage capacity. However, the Fe(VI) forms a ferric overlayer, upon storage the bulk Fe(VI) remains active, but the overlayer passivates the alkaline cathode towards further discharge. This is seen in FIG. 8, in which the fresh pure K₂FeO₄ discharges well, but requires a large fraction (25 wt %) of graphite as a supporting conductive matrix, and the capacity which decreases by an order of magnitude after 7 days of storage. A 1% zirconia coating dramatically improves the capacity after storage, which is further improved with a 5% KOH additive. A low level AgO additive to the cathode, not only facilitates charge transfer, sustaining an effective discharge with a smaller conducting support (10%, rather than 25% graphite), but as seen in FIG. 8 yields an even greater discharge capacity than the uncoated, fresh K₂FeO₄. The initial small 1.4V plateau in this discharge is consistent with the related added AgO reduction.

### EXAMPLE 5

### Energy Advantage of Boride Air Cells

Zn/air cells exhibit among the highest practical volumetric energy of commercialized electrochemical systems. With external oxygen from the ambient atmosphere, Zn/air cells are a hybrid of a battery and a fuel cell. The intrinsic capacity of the zinc air fuel cell is 9.4 kWh/L (based on the 1.6 V theoretical open circuit potential, and 2F per mole, as well 7.1 kg/L density, of zinc.) Commercial zinc air batteries, with a practical cell voltage of 1.3 V and inclusive of the volume of the air catalyst and all other cell components, currently exceed a practical 1.75 kWh/L cell capacity.

Without wishing to be bound by any particular theory, in accord with a formula weight, W=69.5 g mol⁻¹, TiB₂, has a net 6F (F=the faraday constant) intrinsic anodic capacity of 2314 mAh/g. Unlike TiB₂, the alkaline anodic behavior of another tetravalent transition metal boride, a VB₂ salt, W=72.6 g mol⁻¹, undergoes an oxidation of both the tetravalent transition metal ion, V(+4→+5), and each of the borons 2×B(−2→+3), for an unusually high net 11 electron/molecule process, and has an intrinsic 11F (F=the faraday constant) gravimetric anodic capacity of 4060 mAh/g.

Without wishing to be bound to any particular theory, the VB₂ cell reaction for an 11 e⁻ boride air battery and/or fuel cell is given in:

VB₂+11/4O₂→½V₂O₅+B₂O₃ E_{cell}°=1.3 V (9)

Eq. 9 is a result of the 11 e⁻ vanadium boride anodic half reaction, and without being bound to any theory, is expressed:

VB₂+11OH⁻→½V₂O₅+B₂O₃+11/2H₂O+11e⁻ E°=−0.9 V vs SHE (10)

Coupled with an oxygen/air cathode:

O₂+2H₂O+4e⁻→4OH⁻ E°=+0.4 V vs SHE (11)

The equation 9 cell products are generalized as B₂O₃ and V₂O₅, which are the respective anhydride salts of boric acid (H₃BO₃ with pK_{1,2,3}=9.1,12.7 and 13.8) and vanadic acid (H₃VO₄ with pK_{1,2,3}=3.8,7.8 and 13.0). In solution, speciation of the reaction equation 9 product is complex. The products will vary with hydroxide concentration, and depth of discharge, and without being bound to any theory can include cations containing B₂O₃ and V₂O₅, species, such as in either a KOH or NaOH electrolyte: KₓH_{z}BO₃^{3-x-z} or NaₓH_{z}BO₃^{3-x-z} (where x ranges from 0 to 3, and z from 0 to 3-x), as well as polymeric species, such as related to the boric condensation reaction forming borax species: Na_{y}B₄O₇^{2-y}, K_{y}B₄O₇^{2-y}, and analogous vanadium species.

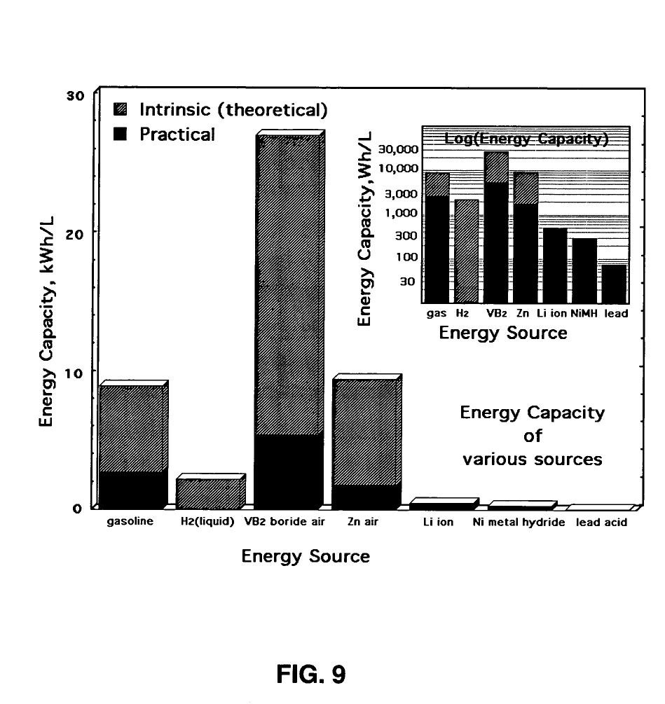

FIG. 9 presents a comparison of the capacity of gasoline and electrochemical energy sources. More specifically, FIG. 9 presents the energy capacity of an alternative vanadium boride air cell compared to systems utilizing gasoline, fuel cells or batteries. The intrinsic energy content of gasoline is released at a maximum practical efficiency of 30% due to Carnot and friction losses. Air fuel cells do not have this Carnot inefficiency, and have practical capacities instead constrained by the requisite volume of the air anode and voltage loss. The volumetric energy capacity of liquid hydrogen is constrained by its low density of 0.0708 kg/L.

Consistent with the VB₂ charge capacity, and density=5.1 kg/L the VB₂/air fuel cell has an intrinsic (theoretical) volumetric energy capacity of (4060 Ah/kg×1.3 V×5.1 kg/L)/(0.0726 kg mol⁻¹)=27 kWh/L (5.3 kWh/kg). This volumetric energy capacity equivalent to 97 MJ/L, is greater than that of gasoline, and is an order of magnitude greater than that of all rechargeable batteries, including Li ion, metal hydride or lead acid. As shown in FIG. 9 the vanadium boride air cell volumetric energy capacity is also substantially greater than that of a liquid hydrogen or a zinc air fuel cell. Air cathode size and voltage loss is similar for the boride and zinc cells. Based on this zinc/air analogue, the practical vanadium boride fuel can approach approximately 20% (20 MJ/L) of the intrinsic cell capacity.

Other embodiments of the stabilized electrodes for electrochemical cells of the present invention, and methods for their design and use, are envisioned beyond those exemplarily described herein.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used. Those skilled in the art should also recognize, or be able to ascertain, using no more than routine experimentation, equivalents to the specific embodiments of the invention. It is therefore to be understood that the embodiments described herein are presented by way of example only and that, within the scope of the appended claims and equivalents thereto, the invention may be practiced otherwise than as specifically described.

What is claimed is:

1. An electrochemical cell, comprising:
an anode comprising a boron-containing material and a stabilizing agent; and
a cathode in electrochemical contact with the anode.

2. The cell of claim 1, wherein the stabilizing agent is substantially insoluble.

3. The cell of claim 2, wherein the stabilizing agent comprises zirconia.

4. The cell of claim 1, wherein the boron-containing material comprises a metal boride material.

5. The cell of claim 4, wherein the metal boride material comprises vanadium diboride.

6. The cell of claim 4, wherein the metal boride material comprises titanium diboride.

7. The cell of claim 1, wherein the cathode comprises an iron (VI) salt.

8. The cell of claim 1, wherein the cathode comprises manganese dioxide.

9. The cell of claim 1, wherein the cathode comprises a nickel-containing material.

10. The cell of claim 1, wherein the cathode comprises a bismuth-containing material.

11. The cell of claim 1, wherein the cathode comprises a periodate material.

12. The cell of claim 1, wherein the cathode comprises silver oxide.

13. The cell of claim 1, wherein the cathode further comprises a stabilizing agent.

14. The cell of claim 13, wherein the stabilizing agent of the cathode comprises zirconia.

15. The cell of claim 1, wherein the electrochemical cell comprises a hydroxide electrolyte.

16. The cell of claim 15, wherein the electrochemical cell is an alkaline battery.

17. The cell of claim 15, wherein the cathode is an air electrode.

18. The cell of claim 15, wherein the cell is substantially rechargeable.

19. The cell of claim 1, wherein the cell is constructed and arranged to generate an electrochemical potential of about 1.5 volts.

20. The cell of claim 19, wherein the cell is constructed and arranged to generate an average electrical discharge of about 1.2 volts to about 1.4 volts.

21. The cell of claim 1, wherein the cell has an electrical storage capacity of at least about 1000 mAh/g of boride salt.

22. The cell of claim 1, wherein the electrochemical cell is a fuel cell.

23. The cell of claim 3, wherein the zirconia stabilizing agent is present in an amount from about 0.1 wt.% to about 10 wt. % of the anode.

24. The cell of claim 23, wherein the zirconia stabilizing agent is present in an amount from about 0.3 wt. % to about 5 wt. % of the anode.

25. The cell of claim 15, wherein the stabilizing agent is a hydroxide ion conductor.

26. A method of generating a current, comprising:
applying a load to a battery including an anode comprising a boron-containing material and a stabilizing agent.

27. A method of facilitating operation of an electrical device, comprising:
providing an electrochemical cell comprising an anode comprising a boron-containing material and a stabilizing agent, the electrochemical cell further comprising a cathode in electrochemical contact with the anode; and
providing instructions directed to connecting the electrochemical cell to the electrical device.

28. An alkaline battery, comprising:
an electrochemical cell constructed and arranged to exhibit an electrical storage capacity of at least about 1000 mAh/g of boride salt.

29. The battery of claim 28, wherein the electrochemical cell is constructed and arranged to exhibit an electrical storage capacity of at least about 2000 mAh/g of boride salt.

30. The battery of claim 28, wherein the electrochemical cell is constructed and arranged to exhibit an electrical storage capacity of at least about 3800 mAh/g of boride salt.

31. An electrochemical cell, comprising:
an anode comprising a boron-containing material; and
an iron(VI) cathode in electrochemical contact with the anode.

32. The electrochemical cell of claim 3 1, wherein the anode further comprises a stabilizing agent.

33. The electrochemical cell of claim 32, wherein the stabilizing agent comprises zirconia.

34. The electrochemical cell of claim 3 1, wherein the cathode further comprises a stabilizing agent.

35. An electrochemical cell, comprising:
a cathode comprising iron (VI) and a stabilizing agent; and
an anode in electrochemical contact with the cathode.

36. The electrochemical cell of claim 35, wherein the cathode stabilizing agent comprises zirconia.

37. An electrochemical cell, comprising:
a cathode comprising a bismuth-containing material and a stabilizing agent; and
an anode in electrochemical contact with the cathode.

38. The electrochemical cell of claim 37, wherein the cathode stabilizing agent comprises zirconia.

39. An electrochemical cell, comprising:
a cathode comprising a nickel-containing material and a stabilizing agent; and
an anode in electrochemical contact with the cathode.

40. The electrochemical cell of claim 39, wherein the cathode stabilizing agent comprises zirconia.
